(19) United States
(12) Patent Application Publication
(10) Pub. No.: US 2025/0390112 A1
(43) Pub. Date: Dec. 25, 2025

(54) PARKING ROBOT AND CONTROL METHOD THEREOF

(71) Applicant: HL Robotics Co., Ltd., Seongnam-si (KR)

(72) Inventor: Sunguk IN, Pyeongtaek-si (KR)

(73) Assignee: HL Robotics Co., Ltd., Seongnam-si (KR)

(21) Appl. No.: 19/244,302

(22) Filed: Jun. 20, 2025

(30) Foreign Application Priority Data
Jun. 20, 2024 (KR) 10-2024-0080576

(51) Int. Cl. G05D 1/667; E04H 6/34; E04H 6/42; G05D 1/243; G05D 111/50; G05D 111/67; G06T 7/50; G06T 7/60; G06T 7/73; G06V 10/25; G06V 20/58

(52) U.S. Cl. CPC G05D 1/667; E04H 6/34; E04H 6/424; G05D 1/2435; G06T 7/50; G06T 7/60; G06T 7/73; G06V 10/25; G06V 20/58; G05D 2111/54; G05D 2111/67; G06T 2207/10024; G06T 2207/20221; G06T 2207/30261; G06V 2201/08

(57) ABSTRACT

Disclosed is a parking robot, including: a driving device moving the parking robot; a camera installed to have a front view of the parking robot; and a controller electrically connected to the driving device and the camera, in which the controller configured to acquire at least one of a color image or a depth map through the camera, determine, based on a fusion of the color image and the depth map, a gap between a first tire and a second tire of a target vehicle located in front of the parking robot and a height from a lower portion of a main body of the target vehicle to ground, and control the driving device so that the parking robot enters the lower portion of the target vehicle based on the gap and the height.

### CROSS-REFERENCE TO RELATED APPLICATIONS

This application claims the priority of Korean Patent Application No. 10-2024-0080576 filed on Jun. 20, 2024, in the Korean Intellectual Property Office, the disclosure of which is incorporated herein by reference.

### BACKGROUND

### Field

The present disclosure relates to a parking robot and a control method thereof.

### Description of the Related Art

Vehicles are a common means of transportation in modern society, and vehicle usage is continuously increasing. This increase in vehicle usage causes a shortage of parking spaces for vehicles. Accordingly, parking spaces are becoming narrower to accommodate many vehicles, and especially, parking spaces in cities where many vehicles are traveling are becoming narrower.

When parking spaces become narrower, drivers are required to have high skill levels when parking their vehicles, and eventually, inexperienced drivers may often cause big or small accidents during parking.

In the past, mechanical parking facilities have been developed and utilized to secure parking spaces and enable efficient parking regardless of the driver's skill level. However, the conventional mechanical parking facilities had the disadvantage of limiting sizes of vehicles that can be parked.

Accordingly, there is a growing demand for parking assistance devices that may maximize the use of conventional parking spaces, regardless of the sizes of the vehicles, while eliminating the need for the driver's skill in parking.

### SUMMARY

An object to be achieved by the present disclosure is to provide a parking robot capable of parking a vehicle by entering a lower portion of the vehicle and moving the vehicle to a parking area, and a control method thereof.

Another object to be achieved by the present disclosure is to provide a parking robot capable of estimating a gap between two tires of a vehicle, a center between two tires, and/or a lower height of the vehicle to determine whether it is possible to enter a lower portion of the vehicle, and a control method thereof.

A parking robot according to an exemplary embodiment of the present disclosure may include: a driving device moving the parking robot; a camera installed to have a front view of the parking robot; and a controller electrically connected to the driving device and the camera, in which the controller may acquire at least one of a color image or a depth map through the camera, determine, based on a fusion of the color image and the depth map, a gap between a first tire and a second tire of a target vehicle located in front of the parking robot and a height from a lower portion of a main body of the target vehicle to ground, and control the driving device so that the parking robot enters the lower portion of the target vehicle based on the gap and the height.

The controller may set a region of interest including regions of the first tire and the second tire in the color image, determine coordinates of bounding box of each of the first tire and the second tire based on the fusion of the color image in which the region of interest is set and the depth map, and determine the gap between the first tire and the second tire based on the coordinates of the bounding box of each of the first tire and the second tire.

The controller may determine the gap between the first tire and the second tire based on the distance between the parking robot and each of the first tire and the second tire through depth values inside the bounding box of each of the first tire and the second tire.

The controller may determine a center coordinate between the first tire and the second tire based on the coordinates of the bounding box of each of the first tire and the second tire, determine coordinates of a pre-specified bounding box of the parking robot based on the center coordinate, determine whether the parking robot can enter the lower portion of the target vehicle based on the coordinates of the bounding box of each of the first tire and the second tire and the coordinates of the pre-specified bounding box of the parking robot, and control the driving device so that the parking robot enters the lower portion of the target vehicle when the parking robot can enter the lower portion of the target vehicle.

The parking robot may further include an output device or a communicator, in which the controller, when the parking robot cannot enter the lower portion of the target vehicle, may perform at least one of control of the output device to output information indicating that a collision occurs when the parking robot enters the lower portion of the target vehicle or control of the communicator to transmit information indicating that the collision occurs to an external server.

The parking robot may further include a steering device, in which the controller may control the steering device to direct the parking robot based on the center coordinate between the first tire and the second tire.

The controller may determine coordinates of the bounding box of the target vehicle based on detection of the target vehicle through the fusion of the color image and the depth map, perform a histogram projection on an inside of the bounding box of the target vehicle in the depth map based on the coordinates of the bounding box of the target vehicle, and determine a gap between the first tire and the second tire and the height from the lower portion of the main body of the target vehicle to the ground based on a maximum value acquired through the histogram projection.

The controller may perform the histogram projection in a vertical direction with respect to the inside of the bounding box of the target vehicle in the depth map, determine regions of the first tire and the second tire in the depth map based on the maximum value acquired through the histogram projection in the vertical direction with respect to the inside of the bounding box of the target vehicle, and determine the gap between the first tire and the second tire based on the regions of the first tire and the second tire in the depth map.

The controller may perform the histogram projection in a horizontal direction with respect to the inside of the bounding box of the target vehicle in the depth map, and determine the height from the lower portion of the main body of the target vehicle to the ground based on the maximum value acquired through the histogram projection in the horizontal direction.

The controller may determine the height from the lower portion of the main body of the target vehicle to the ground based on at least one coordinate having a value less than or equal to a predetermined ratio of the maximum value in the depth map.

The controller may determine whether the parking robot can enter the lower portion of the target vehicle based on the gap, the height, and pre-stored size information of the parking robot, and control the driving device so that the parking robot enters the lower portion of the target vehicle when the parking robot can enter the lower portion of the target vehicle.

A control method of a parking robot according to another exemplary embodiment of the present disclosure may include:

acquiring at least one of a color image or a depth map through a camera of the parking robot; determining, based on a fusion of the color image and the depth map, a gap between a first tire and a second tire of a target vehicle located in front of the parking robot and a height from a lower portion of a main body of the target vehicle to ground; and controlling a driving device of the parking robot so that the parking robot enters the lower portion of the target vehicle based on the gap and the height.

The determining of the gap between the first tire and the second tire may include: setting a region of interest including regions of the first tire and the second tire in the color image; determining coordinates of bounding box of each of the first tire and the second tire based on the fusion of the color image in which the region of interest is set and the depth map; and determining the gap between the first tire and the second tire based on the coordinates of the bounding box of each of the first tire and the second tire.

The determining of the gap between the first tire and the second tire may be based on a distance between the parking robot and each of the first tire and the second tire through depth values inside the bounding box of each of the first tire and the second tire.

The controlling of the driving device of the parking robot so that the parking robot enters the lower portion of the target vehicle may include: determining a center coordinate between the first tire and the second tire based on the coordinates of the bounding box of each of the first tire and the second tire; determining coordinates of a pre-specified bounding box of the parking robot based on the center coordinate; determining whether the parking robot can enter the lower portion of the target vehicle based on the coordinates of the bounding box of each of the first tire and the second tire and the coordinates of the pre-specified bounding box of the parking robot; and controlling the driving device so that the parking robot enters the lower portion of the target vehicle when the parking robot can enter the lower portion of the target vehicle.

The control method of the parking robot may further include, when the parking robot cannot enter the lower portion of the target vehicle, performing at least one of control of the output device of the parking robot to output information indicating that a collision occurs when the parking robot enters the lower portion of the target vehicle or control of the communicator of the parking robot to transmit information indicating that the collision occurs to an external server.

The determining of the gap between the first tire and the second tire and the height from the lower portion of the main body of the target vehicle to the ground may include: determining coordinates of the bounding box of the target vehicle based on detection of the target vehicle through the fusion of the color image and the depth map; performing histogram projection on an inside of the bounding box of the target vehicle in the depth map based on the coordinates of the bounding box of the target vehicle; and determining a gap between the first tire and the second tire and the height from the lower portion of the main body of the target vehicle to the ground based on a maximum value acquired through the histogram projection.

The determining of the gap between the first tire and the second tire may include: performing the histogram projection in a vertical direction with respect to the inside of the bounding box of the target vehicle in the depth map; determining regions of the first tire and the second tire in the depth map based on the maximum value acquired through the histogram projection in the vertical direction with respect to the inside of the bounding box of the target vehicle; and determining the gap between the first tire and the second tire based on the regions of the first tire and the second tire in the depth map.

The determining of the height from the lower portion of the main body of the target vehicle to the ground may include: performing the histogram projection in a horizontal direction with respect to the inside of the bounding box of the target vehicle in the depth map; and determining the height from the lower portion of the main body of the target vehicle to the ground based on the maximum value acquired through the histogram projection in the horizontal direction.

The determining of the height from the lower portion of the main body of the target vehicle to the ground may be based on at least on coordinate having a value less than or equal to a predetermined ratio of the maximum value in the depth map.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a diagram illustrating a parking robot according to an exemplary embodiment;

FIG. 2 is a block diagram illustrating a configuration of the parking robot according to an exemplary embodiment;

FIG. 3 is a flowchart of an operation of the parking robot according to an exemplary embodiment;

FIG. 4 is a flowchart of the operation of the parking robot according to an exemplary embodiment;

FIGS. 5A to 5C are diagrams illustrating data acquired by the parking robot according to an exemplary embodiment; and

FIG. 6 is a flowchart of the operation of the parking robot according to an exemplary embodiment.

### DETAILED DESCRIPTION OF THE EMBODIMENT

Like reference numerals refer to like components throughout the specification. This specification does not describe all the components of the embodiments, and duplicative contents between embodiments general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

The present disclosure is to provide a parking robot that enters a lower portion of a target vehicle, moves the target vehicle to a parking area, and parks the target vehicle. More specifically, the present disclosure is to provide a technology capable of estimating a gap between two tires of the target vehicle, a center between the two tires, and/or a height of the lower portion of the target vehicle in order to determine whether the parking robot can enter the lower portion of the target vehicle.

For example, when applying a lidar to the parking robot, the parking robot may accurately acquire a distance value to the target vehicle or location information of the target vehicle based on point cloud data acquired through the lidar. However, in the case of the point cloud data acquired through the lidar, there is a disadvantage in that it is difficult to accurately acquire the information of the target vehicle corresponding to the detailed size and location information since the gap between the point data is wide.

Accordingly, the present disclosure may provide a technology capable of accurately acquiring the information on the target vehicle described above by applying a camera capable of acquiring a color image and a depth map to the parking robot in order to complement the above-described disadvantage of the lidar.

Hereinafter, operating principles and exemplary embodiments of the present disclosure will be described with reference to the attached drawings.

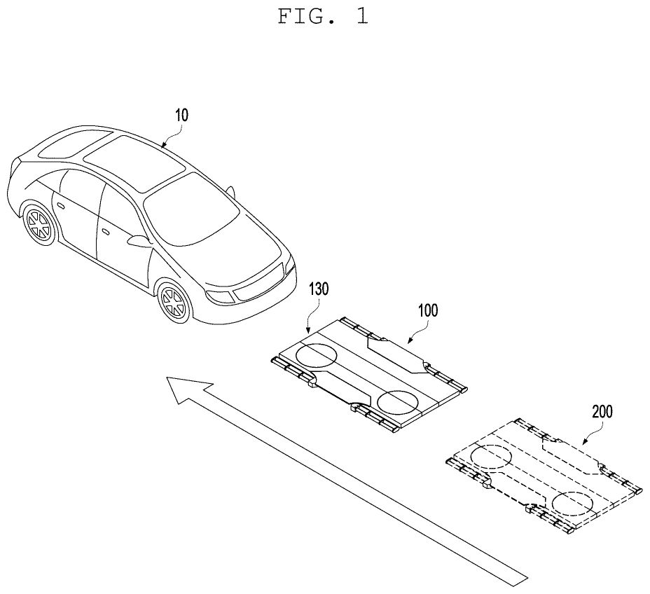

FIG. 1 is a diagram illustrating a parking robot according to an exemplary embodiment.

Referring to FIG. 1, a parking robot 100 may move to a lower portion of a target vehicle 10 and park the target vehicle 10 in a parking area.

For example, although not illustrated in FIG. 1, the parking robot 100 may move to the lower portion of the target vehicle 10, move to the parking area while lifting the target vehicle 10, and lower the target vehicle 10 when arriving at the parking area, thereby parking the target vehicle 10.

For example, the parking robot 100 may cooperate with another parking robot 200 through data communication with another parking robot 200 to park the target vehicle 10 in the parking area, or may park the target vehicle 10 in the parking area alone.

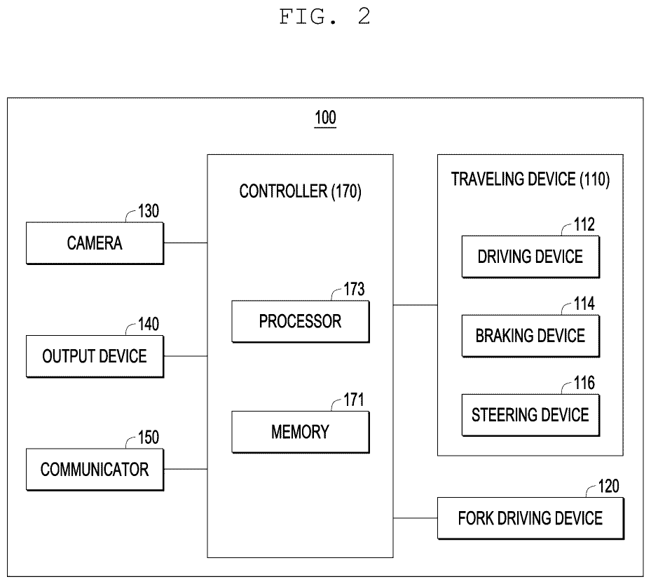

FIG. 2 is a block diagram illustrating a configuration of the parking robot 100 according to an exemplary embodiment.

Referring to FIG. 2, the parking robot 100 may include a traveling device 110, a fork driving device 120, a camera 130, an output device 140, a communicator 150, and/or a controller 170.

The traveling device 110 may perform movement, stop, and/or change in moving direction of the parking robot 100.

The traveling device 110 may include a driving device 112, a braking device 114, and/or a steering device 116.

The driving device 112 may move the parking robot 100. For example, the driving device 112 may include a motor (or an electric motor), and may provide a driving force to the motor to rotate a wheel (or an electric wheel) of the parking robot 100 so that the parking robot 100 moves.

For example, the parking robot 100 may have one or a plurality of wheels, and may be implemented in various ways depending on the design.

The braking device 114 may stop the movement of the parking robot 100. For example, the braking device 114 may stop the parking robot 100 by including components such as a brake pad and a disc.

The steering device 116 may change the movement direction of the parking robot 100. For example, the steering device 116 may change the movement direction of the parking robot 100 by including components such as a motor or a hydraulic system that controls the direction of the wheel of the parking robot 100.

A fork driving device 120 may include one or more motors that may provide the driving force for the movement of a plurality of forks (not shown) of the parking robot 100.

Although not illustrated, the parking robot 100 may include the plurality of forks that extend from a main body to both sides to support front wheels and/or rear wheels on both sides of the target vehicle 10.

For example, each fork of the parking robot 100 may be implemented with a structure in which it may change from a folded state to an unfolded state and from an unfolded state to a folded state under the control of the fork driving device 120 by the controller 170.

In addition, each fork of the parking robot 100 may be implemented with a structure in which it may be lifted upward and lowered downward under the control of the fork driving device 120 by the controller 170 in the unfolded state.

As another example, each fork of the parking robot 100 may be implemented with a structure in which it may change to extend outward from the main body under the control of the fork driving device 120 by the controller 170, and then contract toward the main body while extending outward.

In addition, each fork of the parking robot 100 may be implemented with a structure in which it may be lifted upward and lowered downward under the control of the fork driving device 120 by the controller 170 while extending outward based on the main body.

The camera 130 may acquire image data around the parking robot 100. For example, the camera 130 may include a plurality of lenses (not illustrated), an image sensor, and/or an image processor (not illustrated).

The camera 130 may include an RGB-depth (RGB D) camera capable of acquiring a color image and a depth map.

There may be one or more cameras 130, and the cameras may be disposed on the main body of the parking robot 100 so that the parking robot 100 has a field of view toward the surroundings.

Referring to FIG. 1, the camera 130 may be disposed on the main body of the parking robot 100 so that the parking robot 100 has the field of view toward a first direction (or also referred to as forward) in which the parking robot 100 moves.

The output device 140 may output information, and may include a display capable of outputting visual information and/or a speaker capable of outputting auditory information, etc.

The communicator 150 may support the establishment of a wireless communication channel between the parking robot 100 and an external device, for example, between an external server (not illustrated) and/or another parking robot 200 and the performance of communication through the established communication channel, and may include a communication circuit and/or a control circuit capable of controlling the operation of the communication circuit.

The communicator 150 may communicate with an external device through any one of a cellular communication module, a Wi-Fi communication module, a short-range wireless communication module (e.g., a Bluetooth communication module), and/or a global navigation satellite system (GNSS) communication module.

The controller 170 may be electrically connected and/or communicatively connected to each component of the parking robot 100, for example, the traveling device 110, the fork driving device 120, the camera 130, the output device 140, and/or the communicator 150, and may control each component.

For example, the controller 170 may process data acquired through the camera 130, and may process data received from an external device, for example, an external server, and/or the second parking robot 200, through the communicator 150. In addition, the controller 170 may provide a control signal to the corresponding component among the traveling device 110, the fork driving device 120, the camera 130, the output device 140, and/or the communicator 150 based on the processing result of the data acquired through the camera 130 and/or the processing result of the data received through the communicator 150.

The controller 170 may acquire positioning information including posture information of the parking robot 100 and relative posture information with respect to the second parking robot 200 based on the data acquired through, for example, the camera 130 by utilizing the wheel odometry technology. For example, the posture information of the parking robot 100 may include the location information of the parking robot 100, and the relative posture information with respect to the second parking robot 200 may include the relative location information with respect to the second parking robot 200.

The controller 170 may determine whether the parking robot 100 may enter the lower portion of the target vehicle 10 based on the data acquired through the camera 130.

For example, the controller 170 may acquire the color image and the depth map through the camera 130, and determine whether the parking robot 100 may enter the lower portion of the target vehicle 10 between the first tire and the second tire located on the same axis of the target vehicle 10 based on the acquired color image and depth map.

For example, the first tire and the second tire may be located on the same axle of the target vehicle 10. The first tire and the second tire may be front wheels of the vehicle 1. Alternatively, the first tire and the second tire may be rear wheels of the vehicle 1.

A detailed exemplary embodiment of determining whether the parking robot 100 may enter the lower portion of the target vehicle 10 is described below.

When the parking robot 100 may enter the lower portion of the target vehicle 10, the controller 170 may control the driving device 112 and/or the steering device 116 included in the traveling device 110 based on the data acquired through the camera 130 and/or the data communication with the second parking robot 200 through the communicator 150 to move the parking robot 100 to the lower portion of the vehicle 10.

The controller 170 may lift the plurality of forks upward after having the plurality of forks support the front wheels and/or the rear wheels on both sides of the target vehicle 10.

In addition, the controller 170 may control the driving device 112 included in the traveling device 110 to move to the parking area while lifting the plurality of forks upward.

In addition, the controller 170 may control the plurality of forks to lower and the plurality of forks to release the support of the front wheels and/or the rear wheels on both sides after moving to the parking area.

For example, the controller 170 may lift and move the wheels of the target vehicle 10 together with the parking robot 200 by the cooperative control with the parking robot 200 through the communicator 150, and for example, the parking robot 100 may lift the front wheels on both sides and lift the rear wheels on both sides to move together. In addition, the controller 170 may lower the wheels of the target vehicle 10 to the parking area together with the parking robot 200 by the cooperative control with the parking robot 200 through the communicator 150, and for example, the parking robot 100 may lower the front wheels on both sides and lower the rear wheels on both sides, so that the target vehicle 10 may be parked in the specified parking area.

The controller 170 may include a memory 171 and/or a processor 173.

The memory 171 may store a software program for the parking robot 100. The memory 171 may store a program and/or data for processing each data (data acquired through the camera 130 and/or data received through the communicator 150, etc.).

The memory 171 may temporarily store each data and temporarily store the processing results of each data by the processor 173.

The memory 171 may include not only volatile memories such as S-RAM and D-RAM, but also non-volatile memory such as flash memory, read only memory (ROM), and erasable programmable read only memory (EPROM).

The processor 173 may process each data and provide signals for controlling the traveling device 110, the fork driving device 120, the camera 130, the output device 140, and/or the communicator 150, respectively, to the corresponding devices. For example, the processor 173 may include a micro controller (MCU).

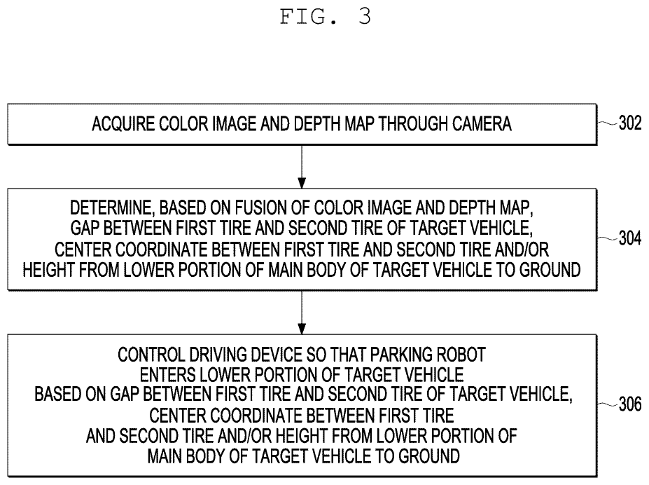

FIG. 3 is a flowchart of the operation of the parking robot 100 (and/or the controller 170) according to an exemplary embodiment.

Referring to FIG. 3, the parking robot 100 may acquire the color image and the depth map through the camera 130 (302).

For example, when the camera 130 of the parking robot 100 is installed on the main body of the parking robot 100 so that the camera 130 has the front view of the parking robot 100 and the target vehicle 10 is located in front of the parking robot 100, the parking robot 100 may acquire a color image and a depth map corresponding to a front image of the target vehicle 10 through the camera 130.

Based on the fusion of the color image and the depth map, the parking robot 100 may determine a gap between the first tire and the second tire located on the same axis of the target vehicle 10, a center coordinate between the first tire and the second tire, and/or a height from the lower portion of the main body of the target vehicle 10 to the ground (304).

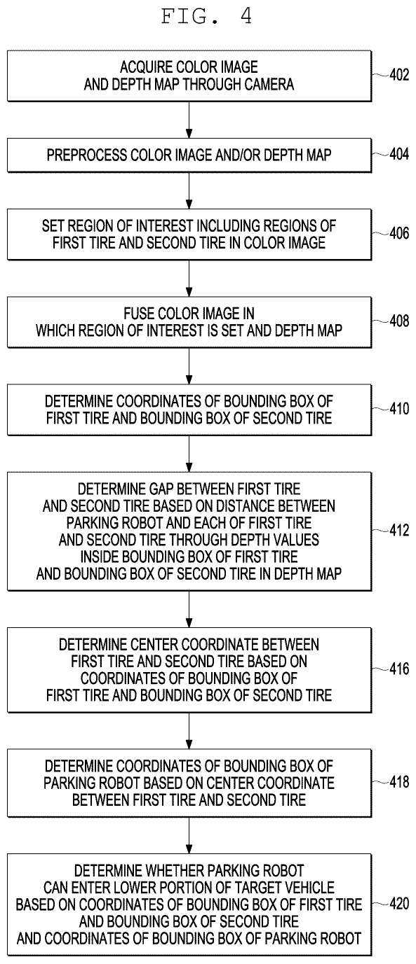

Detailed exemplary embodiments of determining the gap between the first tire and the second tire of the target vehicle 10, the center coordinate between the first tire and the second tire, and/or the height from the lower portion of the main body of the target vehicle 10 to the ground are described in detail with reference to FIGS. 4 to 6 to be described below.

The parking robot 100 may control the driving device 112 so that the parking robot 100 enters the lower portion of the target vehicle 10 based on the gap between the first tire and the second tire of the target vehicle 10, the center coordinate between the first tire and the second tire, and/or the height from the lower portion of the main body of the target vehicle 10 to the ground (306).

It may determine whether the parking robot 100 can enter the lower portion of the target vehicle 10 based on the gap between the first tire and the second tire and the height from the lower portion of the main body of the target vehicle 10 to the ground.

For example, the memory 171 may store the pre-stored size information of the parking robot 100, and the parking robot 100 may determine whether the parking robot 100 can enter the lower portion of the target vehicle 10 based on the gap between the first tire and the second tire, the height from the lower portion of the main body of the target vehicle 10 to the ground, and the pre-stored size information of the parking robot 100.

As another example, the memory 171 may pre-store size information of bounding box of the parking robot 100, and the parking robot 100 may determine whether the parking robot 100 can enter the lower portion of the target vehicle 10 based on coordinates of bounding box of each of the first and second tires determined while performing the above-described operations and coordinates of the bounding box of the parking robot 100 determined while performing the above-described operations. A detailed exemplary embodiment of determining the coordinates of the bounding box of each of the first and second tires and the coordinates of the bounding box of the parking robot 100 will be described below.

When the parking robot 100 can enter the lower portion of the target vehicle 10, the driving device 112 may be controlled so that the parking robot 100 enters the lower portion of the target vehicle 10 through the gap between the first tire and the second tire.

For example, the steering device 116 may be controlled so that the parking robot 100 enters the lower portion of the target vehicle 10 through the first tire and the second tire based on the center coordinate between the first tire and the second tire to control the direction of the parking robot 100, and the driving device 112 may be controlled to move the parking robot 100.

Meanwhile, in addition to the exemplary embodiment of FIG. 3 described above, when the parking robot 100 cannot enter the lower portion of the target vehicle 10, to enable a manager of the parking robot 100 and/or an owner of the target vehicle 10 to be informed of the fact, the parking robot 100 may perform the control of the output device 140 of the parking robot 100 to output information indicating that a collision has occurred when the parking robot 100 enters the lower portion of the target vehicle 10 and/or the control of the communicator 150 of the parking robot 100 to transmit the information to an external server.

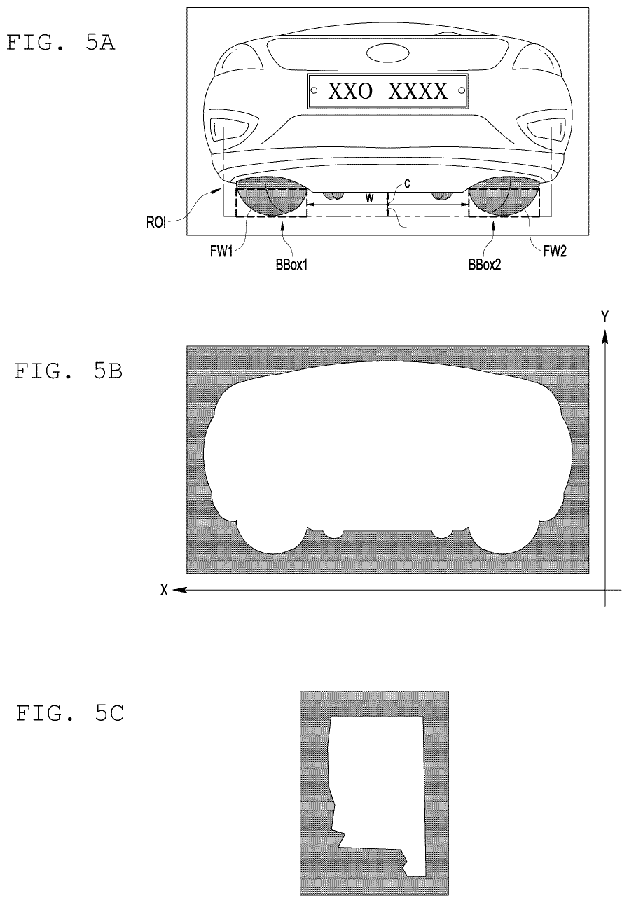

FIG. 4 is a flowchart of the operation of the parking robot 100 (and/or the controller 170) according to an exemplary embodiment. FIGS. 5A to 5C are diagrams illustrating the data acquired by the parking robot 100 (and/or the controller 170) according to one exemplary embodiment.

Referring to FIG. 4, the parking robot 100 may acquire the color image and the depth map through the camera 130 (402).

For example, the parking robot 100 may acquire the color image corresponding to the front image of the target vehicle 10, as illustrated in FIG. 5A. In addition, the parking robot 100 may acquire the depth map of the front image of the target vehicle 10, as illustrated in FIG. 5B.

The parking robot 100 may preprocess the color image and/or the depth map (404).

For example, the parking robot 100 may preprocess the color image by converting the color image from a red green blue (RGB) color space into a hue saturation value (HSV) color space and then performing noise removal through Gaussian blur, etc., histogram equalization, and/or image normalization, etc.

In addition, the parking robot 100 may preprocess the depth map by removing noise from the depth map and/or normalizing the depth value through a Gaussian filter, etc.

The parking robot 100 may set a region of interest (ROI) including regions of a first tire FW1 and a second tire FW2 in the preprocessed color image as illustrated in FIGS. 5A to 5C (406).

The parking robot 100 may set the region of interest through an object detection technology.

The parking robot 100 can fuse the color image in which the region of interest ROI is set and the preprocessed depth map (408).

The parking robot 100 may determine the coordinates of the bounding box of the first tire FW1 and the bounding box of the second tire FW2 based on the fusion of the color image in which the region of interest ROI is set and the preprocessed depth map (410).

For example, the parking robot 100 may generate bounding boxes BBox1 and BBox2 of the first tire FW1 and the second tire FW2 as illustrated in FIG. 5A. The parking robot 100 may determine the coordinates of the bounding box BBox1 of the first tire RW1 and BBox2 of the second tire FW2 based on the parking robot 100, for example, coordinates of each corner of each of the bounding boxes BBox1 and BBox2.

The parking robot 100 may determine a gap w between the first tire FW1 and the second tire FW2 based on a distance between the parking robot 100 and each of the first tire FW1 and the second tire FW2 through depth values of insides of the bounding box BBox1 of the first tire FW1 and bounding box BBox2 of the second tire FW2 in the depth map (412).

For example, the parking robot 100 may identify the insides of the bounding box BBOX1 of the first tire FW1 and the bounding box BBOX2 of the second tire FW2 in the depth map, based on the coordinates of the bounding boxes BBOX1 and BBOX2.

The parking robot 100 may determine a center coordinate c between the first tire FW1 and the second tire FW2 based on the coordinates of the bounding box BBOX1 of the first tire FW1 and the bounding box BBOX2 of the second tire FW2 (416).

The parking robot 100 may determine the coordinates of the bounding box of the parking robot 100 based on the center coordinate c between the first tire FW1 and the second tire FW2 (418).

The bounding box of the parking robot 100 may be specified in advance. For example, the size information of the bounding box of the parking robot 100 may be stored in the memory 171.

The parking robot 100 may determine the coordinates of the bounding box of the parking robot 100 so that the center coordinate c between the first tire FW1 and the second tire FW2 becomes the center coordinate of the bounding box of the parking robot 100.

The parking robot 100 may determine whether the parking robot 100 can enter the lower portion of the target vehicle 10 based on the coordinates of the bounding box BBOX1 of the first tire FW1 and the bounding box BBOX2 of the second tire FW2 and the coordinates of the bounding box of the parking robot 100 (420).

The parking robot 100 may identify whether the bounding box of the parking robot 100 overlaps at least a portion of the bounding boxes BBOX1 and BBOX2 of the first tire FW1 and the second tire FW2, based on the coordinates of the bounding boxes of each of the first tire FW1 and the second tire FW2 and the coordinates of the bounding box of the parking robot 100.

When the bounding box of the parking robot 100 overlaps at least a portion of the bounding boxes BBOX1 and BBOX2 of the first tire FW1 and the second tire FW2, the parking robot 100 may determine that the parking robot 100 cannot enter the lower portion of the target vehicle 10.

When the bounding box of the parking robot 100 overlaps at least a portion of the bounding boxes BBOX1 and BBOX2 of the first tire FW1 and the second tire FW2, the parking robot 100 may determine that the parking robot 100 can enter the lower portion of the target vehicle 10.

Meanwhile, in the exemplary embodiment of FIGS. 5A to 5C described above, it was described that the coordinates of the bounding box of each of the first tire and the second tire are determined by setting the region of interest including the regions of the first tire and the second tire in the color image and fusing the color image in which the region of interest is set and the depth map. However, in another exemplary embodiment, the coordinates of the bounding box of each of the first tire and the second tire may be determined by fusing the color image and the depth map and then setting the region of interest including the regions of the first tire and the second tire.

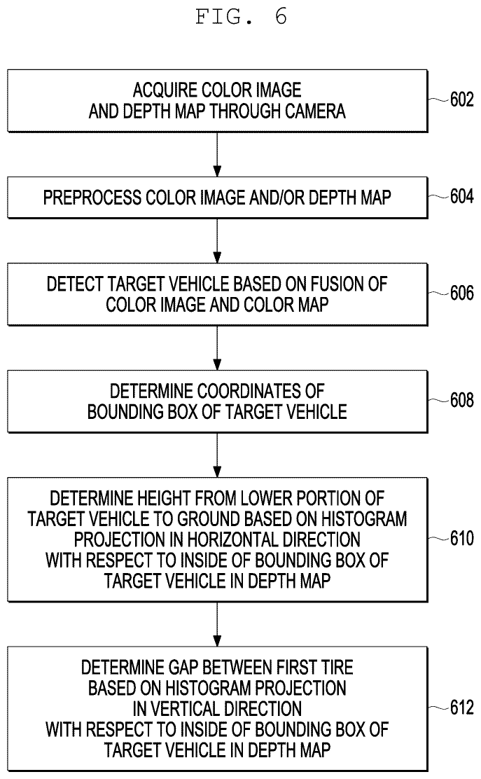

FIG. 6 is a flowchart of the operation of the parking robot 100 (and/or the controller 170) according to an exemplary embodiment.

Referring to FIG. 6, the parking robot 100 may acquire the color image and the depth map through the camera 130 (602).

The parking robot 100 may preprocess the color image and/or the depth map (604).

For example, the parking robot 100 may preprocess the color image by converting the color image from the red green blue (RGB) color space into the hue saturation value (HSV) color space and then performing the noise removal through the Gaussian blur, etc., the histogram equalization, and/or the image normalization, etc.

In addition, the parking robot 100 may preprocess the depth map by removing the noise from the depth map and/or normalizing the depth value through the Gaussian filter, etc.

The parking robot 100 may detect the target vehicle 10 based on the fusion of the color image and the depth map (606).

The parking robot 100 may detect the target vehicle 10 through the object detection technology.

For example, the parking robot 100 may detect the target vehicle 10 based on the fusion of the color image and the depth map after setting the region of interest (ROI) including the region of the target vehicle 10 in the color image.

As another example, the parking robot 100 may detect the target vehicle 10 based on the setting of the region of interest after the fusion of the color image and the depth map.

The parking robot 100 may determine the coordinates of the bounding box of the target vehicle 10 (608).

The parking robot 100 may determine a height h from the lower portion of the main body of the target vehicle 10 to the ground based on the histogram projection in the horizontal direction with respect to the inside of the bounding box of the target vehicle 10 in the depth map (610).

Referring to FIG. 5B, the parking robot 100 may acquire data such as FIG. 5C through the histogram projection in the horizontal direction x with respect to the inside of the bounding box of the target vehicle 10 in the depth map.

The parking robot 100 may determine the height from the lower portion of the main body of the target vehicle 10 to the ground based on a maximum value acquired through the histogram projection in the horizontal direction x.

For example, the parking robot 100 may determine a coordinate having a value (y-coordinate value among the x, y-coordinate values) less than or equal to a predetermined ratio of the maximum value acquired through the histogram projection in the horizontal direction x as a starting point of the lower portion of the main body of the target vehicle 10 in the depth map, and determine the height from the lower portion of the main body of the target vehicle 10 to the ground.

For example, in the lower portion area of the target vehicle 10 between the first tire TW1 and the second tire TW2, the value of the depth map may be 0, and accordingly, by considering that the value acquired through the histogram projection in the horizontal direction x is lowered to be less than or equal to a specific value, the parking robot 100 may determine a coordinate having a value less than or equal to the predetermined ratio of the maximum value acquired through the histogram projection in the horizontal direction x in the depth map as the starting point of the lower portion of the main body of the target vehicle 10.

The parking robot 100 may determine the gap between the first tire FW1 and the second tire FW2 based on the histogram projection in the vertical direction with respect to the inside of the bounding box of the target vehicle 10 in the depth map (612).

Referring to FIG. 5B, the parking robot 100 may perform the histogram projection in the vertical direction y with respect to the inside of the bounding box of the target vehicle 10 in the depth map, and identify the maximum value among the values acquired through the histogram projection in the vertical direction y.

The parking robot 100 may acquire the regions of each of the first tire FW1 and the second tire FW2 in the depth map based on the maximum value acquired through the histogram projection in the vertical direction y.

For example, the parking robot 100 may acquire the regions of each of the first tire FW1 and the second tire FW2 based on the maximum value acquired through the histogram projection in the vertical direction y and the regions of interest of each of the first tire FW1 and the second tire FW2. For example, the regions of interest of each of the first tire FW1 and the second tire FW2 may be set before the fusion of the color image and the depth map, or set after the fusion of the color image and the depth map.

Meanwhile, in addition to the above-described exemplary embodiments, the parking robot 100 (and/or the controller 170) may extract edges of the first tire FW1 and the second tire FW2 through a difference in brightness between the first tire FW1 and the second tire FW2 and a portion other than the first tire FW1 and the second tire FW2 from the color image. For example, the parking robot 100 may extract the edges of the first tire FW1 and the second tire FW2 based on the comparison of the brightness in the bounding box of each of the first tire FW1 and the second tire FW2 described above.

The parking robot 100 may identify the coordinates of the first tire FW1 and the second tire FW2 through the extraction of the edges of the first tire FW1 and the second tire FW2, and identify the distance between the first tire FW1 and the second tire FW2 and/or the center coordinate between the first tire FW1 and the second tire FW2.

In addition, in addition to the above-described exemplary embodiments, the parking robot 100 may utilize the object detection and sensor fusion technology. The main body of the parking robot 100 is provided with a lidar, and 3D data on the target vehicle 10 may be acquired by the fusion of the data acquired through the camera 100 described above and the point cloud data acquired by the lidar.

For example, the parking robot 100 may recognize objects around the parking robot 100 based on the point cloud data acquired through the lidar. In addition, the parking robot 100 may accurately acquire the information on the target vehicle 10, the centers of each of the first tire FW1 and the second tire FW2 of the target vehicle, the empty space between the first tire FW1 and the second tire FW2, the center between the first tire FW1 and the second tire FW2, etc., based on the data acquired through the camera 130 as the subsequent processing, for example, the color image and the depth map, according to the above-described exemplary embodiments.

In addition, for example, the parking robot 100 may identify a license plate of the target vehicle 10 and a vehicle number included in a license plate of the target vehicle 10 through the object detection based on the data acquired through the camera 130.

According to the above-described exemplary embodiments, to determine whether the parking robot capable of entering the lower portion of the vehicle, moving the vehicle to the parking area, and parking the vehicle can enter the lower portion of the vehicle, a technology capable of estimating the gap between two tires of the vehicle, the center between two tires, and/or the height of the lower portion of the vehicle may be provided.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A parking robot, comprising:
a driving device moving the parking robot;
a camera installed to have a front view of the parking robot; and
a controller electrically connected to the driving device and the camera,
wherein the controller configured to acquire at least one of a color image or a depth map through the camera,
determine, based on a fusion of the color image and the depth map, a gap between a first tire and a second tire of a target vehicle located in front of the parking robot and a height from a lower portion of a main body of the target vehicle to ground, and
control the driving device so that the parking robot enters the lower portion of the target vehicle based on the gap and the height.

2. The parking robot according to claim 1, wherein the controller configured to set a region of interest including regions of the first tire and the second tire in the color image,
determine coordinates of bounding box of each of the first tire and the second tire based on the fusion of the color image in which the region of interest is set and the depth map, and
determine the gap between the first tire and the second tire based on the coordinates of the bounding box of each of the first tire and the second tire.

3. The parking robot according to claim 2, wherein the controller configured to determine the gap between the first tire and the second tire based on a distance between the parking robot and each of the first tire and the second tire through depth values inside the bounding box of each of the first tire and the second tire.

4. The parking robot according to claim 2, wherein the controller configured to determine a center coordinate between the first tire and the second tire based on the coordinates of the bounding box of each of the first tire and the second tire,
determine coordinates of a pre-specified bounding box of the parking robot based on the center coordinate,
determine whether the parking robot can enter the lower portion of the target vehicle based on the coordinates of the bounding box of each of the first tire and the second tire and the coordinates of the pre-specified bounding box of the parking robot, and
control the driving device so that the parking robot enters the lower portion of the target vehicle when the parking robot can enter the lower portion of the target vehicle.

5. The parking robot according to claim 4, further comprising:
an output device or a communicator,
wherein the controller configured to, when the parking robot cannot enter the lower portion of the target vehicle, perform at least one of control of the output device to output information indicating that a collision occurs when the parking robot enters the lower portion of the target vehicle or control of the communicator to transmit information indicating that the collision occurs to an external server.

6. The parking robot according to claim 4, further comprising:
a steering device,
wherein the controller configured to control the steering device to direct the parking robot based on the center coordinate between the first tire and the second tire.

7. The parking robot according to claim 1, wherein the controller configured to determine coordinates of a bounding box of the target vehicle based on detection of the target vehicle through a fusion of the color image and the depth map,
perform a histogram projection on an inside of the bounding box of the target vehicle in the depth map based on the coordinates of the bounding box of the target vehicle, and
determine a gap between the first tire and the second tire and the height from the lower portion of the main body of the target vehicle to the ground based on a maximum value acquired through the histogram projection.

8. The parking robot according to claim 7, wherein the controller configured to perform the histogram projection in a vertical direction with respect to the inside of the bounding box of the target vehicle in the depth map,
determine regions of the first tire and the second tire in the depth map based on the maximum value acquired through the histogram projection in the vertical direction with respect to the inside of the bounding box of the target vehicle, and
determine the gap between the first tire and the second tire based on the regions of the first tire and the second tire in the depth map.

9. The parking robot according to claim 7, wherein the controller configured to perform the histogram projection in a horizontal direction with respect to the inside of the bounding box of the target vehicle in the depth map, and
determine the height from the lower portion of the main body of the target vehicle to the ground based on the maximum value acquired through the histogram projection the horizontal direction.

10. The parking robot according to claim 9, wherein the controller configured to determine the height from the lower portion of the main body of the target vehicle to the ground based on at least one coordinate having a value less than or equal to a predetermined ratio of the maximum value in the depth map.

11. The parking robot according to claim 1, wherein the controller configured to determine whether the parking robot can enter the lower portion of the target vehicle based on the gap, the height, and pre-stored size information of the parking robot, and
control the driving device so that the parking robot enters the lower portion of the target vehicle when the parking robot can enter the lower portion of the target vehicle.

12. A control method of a parking robot, comprising:
acquiring at least one of a color image or a depth map through a camera of the parking robot;
determining, based on a fusion of the color image and the depth map, a gap between a first tire and a second tire of a target vehicle located in front of the parking robot and a height from a lower portion of a main body of the target vehicle to ground; and
controlling a driving device of the parking robot so that the parking robot enters the lower portion of the target vehicle based on the gap and the height.

13. The control method according to claim 12, wherein the determining of the gap between the first tire and the second tire includes:
setting a region of interest including regions of the first tire and the second tire in the color image;
determining coordinates of bounding box of each of the first tire and the second tire based on the fusion of the color image in which the region of interest is set and the depth map; and
determining the gap between the first tire and the second tire based on the coordinates of the bounding box of each of the first tire and the second tire.

14. The control method according to claim 13, wherein the determining of the gap between the first tire and the second tire is based on a distance between the parking robot and each of the first tire and the second tire through depth values inside the bounding box of each of the first tire and the second tire.

15. The control method according to claim 13, wherein the controlling of the driving device of the parking robot so that the parking robot enters the lower portion of the target vehicle includes:
determining a center coordinate between the first tire and the second tire based on the coordinates of the bounding box of each of the first tire and the second tire;
determining coordinates of a pre-specified bounding box of the parking robot based on the center coordinate;
determining whether the parking robot can enter the lower portion of the target vehicle based on the coordinates of the bounding box of each of the first tire and the second tire and the coordinates of the pre-specified bounding box of the parking robot; and
controlling the driving device so that the parking robot enters the lower portion of the target vehicle when the parking robot can enter the lower portion of the target vehicle.

16. The control method according to claim 15, further comprising:
when the parking robot cannot enter the lower portion of the target vehicle, performing at least one of control of the output device of the parking robot to output information indicating that a collision occurs when the parking robot enters the lower portion of the target vehicle or control of the communicator of the parking robot to transmit information indicating that the collision occurs to an external server.

17. The control method according to claim 12, wherein the determining of the gap between the first tire and the second tire and the height from the lower portion of the main body of the target vehicle to the ground includes:
determining coordinates of the bounding box of the target vehicle based on detection of the target vehicle through the fusion of the color image and the depth map;
performing histogram projection an inside of the bounding box of the target vehicle in the depth map based on the coordinates of the bounding box of the target vehicle; and
determining the gap between the first tire and the second tire and the height from the lower portion of the main body of the target vehicle to the ground based on a maximum value acquired through the histogram projection.

18. The control method according to claim 17, wherein the determining of the gap between the first tire and the second tire includes:
performing the histogram projection in a vertical direction with respect to the inside of the bounding box of the target vehicle in the depth map;
determining regions of the first tire and the second tire in the depth map based on the maximum value acquired through the histogram projection in the vertical direction with respect to the inside of the bounding box of the target vehicle; and
determining the gap between the first tire and the second tire based on the regions of the first tire and the second tire in the depth map.

19. The control method according to claim 17, wherein the determining of the height from the lower portion of the main body of the target vehicle to the ground includes:
performing the histogram projection in a horizontal direction with respect to the inside of the bounding box of the target vehicle in the depth map; and
determining the height from the lower portion of the main body of the target vehicle to the ground based on the maximum value acquired through the histogram projection in the horizontal direction.

20. The control method according to claim 19, wherein the determining of the height from the lower portion of the main body of the target vehicle to the ground is based on at least one coordinate having a value less than or equal to a predetermined ratio of the maximum value in the depth map.
